(19) United States
(12) Patent Application Publication
(10) Pub. No.: US 2007/0088138 A1
(43) Pub. Date: Apr. 19, 2007

(54) EPOXY/ELASTOMER ADDUCT, METHOD OF FORMING SAME AND MATERIALS AND ARTICLES FORMED THEREWITH

(75) Inventors: Michael J. Czaplicki, Rochester, MI (US); Christopher Hable, Romeo, MI (US); David Carlson, Rochester Hills, MI (US); Craig Chmielewski, Shelby Township, MI (US)

Correspondence Address: DOBRUSIN & THENNISCH PC, 29 W LAWRENCE ST, SUITE 210, PONTIAC, MI, 48342, US

(73) Assignee: L&L Products, Inc., Romeo, MI (US)

(21) Appl. No.: 11/560,486

(22) Filed: Nov. 16, 2006

Related U.S. Application Data
(62) Division of application No. 10/783,326, filed on Feb. 20, 2004.
(60) Provisional application No. 60/451,811, filed on Mar. 4, 2003.

(51) Int. Cl. C08L 63/02; C08J 9/06

(52) U.S. Cl. 525/524; 521/119

(57) ABSTRACT

An epoxy/elastomer adduct, a method of forming the adduct and materials and articles incorporating the adduct are disclosed. The adduct preferably includes up to about 60% by weight of an elastomeric component, up to about 90% by weight of an epoxy component and optionally one or more additives.

The present application claims the benefit of the filing date of U.S. Provisional Application Ser. No. 60/451,811, filed Mar. 4, 2003, hereby incorporated by reference.

### FIELD OF THE INVENTION

The present invention relates generally to an epoxy/elastomer adduct, a method of forming the adduct and material and articles that can be formed with the adduct.

### BACKGROUND OF THE INVENTION

For many years industry, and particularly the transportation industry, has been concerned with the creation of materials for performing functions such as adhesion, sealing, baffling, acoustic attenuation, reinforcement, a combination thereof or the like to articles of manufacture such as automotive vehicles. As a result, industry has developed a wide variety of materials for providing such functions. In the interest of continuing such innovation, there is provided an epoxy/elastomer adduct, a method of forming the adduct and one or more material and articles, which may be formed with the adduct.

### SUMMARY OF THE INVENTION

Accordingly, the present invention provides an epoxy/elastomer adduct. The adduct is particularly suitable for incorporation into materials used for adhesion, reinforcement, sealing, baffling or the like. Such materials will typically include, in addition to the adduct, one or more of the following ingredients: a filler, an epoxy resin, an elastomeric component, a curing agent, a blowing agent or the like. In one exemplary preferred embodiment, the adduct is used to form an adhesive material that exhibits adhesive characteristics that are relatively insensitive to bondline size (e.g., thickness) of the applied adhesive.

### DETAILED DESCRIPTION

The present invention is predicated upon an improved epoxy/elastomer adduct, a method of forming the adduct along with material and articles incorporating the adduct. The adduct, by itself or as part of another material, preferably assists in providing structural reinforcement, adhesion, sealing, acoustical damping properties or a combination thereof within a cavity of or upon a surface of a structure, or to one or more structural members (e.g., a body panel or structural member) of an article of manufacture (e.g., an automotive vehicle).

The adduct preferably includes:
(a) at least about 10% or less and up to about 90% or more by weight of an epoxy component that is preferably provided as an epoxy resin;
(b) at least about 5% or less and up to about 60% or more by weight of an elastomeric component that is preferably provided as a solid; and
(c) optionally, one or more additives

The epoxy may be supplied as a solid (e.g., as pellets, chunks, pieces or the like), as a liquid or a combination thereof. Preferably, the epoxy component is provided as a resin although not required. Epoxy resin is used herein to mean any of the conventional dimeric, oligomeric or polymeric epoxy materials containing at least one epoxy functional group. Epoxy resin can also mean a single resin or a mixture of resins. The epoxy component may be any epoxy-containing material, which preferably includes one or more oxirane rings polymerizable by a ring opening reaction. In preferred embodiments, the adduct includes up to about 97% or more by weight of an epoxy resin. More preferably, the adduct includes between about 50% and 90% by weight epoxy resin and still more preferably between about 70% and 85% by weight epoxy resin.

The epoxy may be aliphatic, cycloaliphatic, aromatic or the like. The epoxy may include an ethylene copolymer or terpolymer that may possess an alpha-olefin. As a copolymer or terpolymer, the polymer is composed of two or three different monomers, i.e., small molecules with high chemical reactivity that are capable of linking up with similar molecules. One exemplary epoxy resin may be a phenolic resin, which may be a novalac type or other type resin. Other preferred epoxy containing materials may include a bisphenol-A epichlorohydrin ether polymer, a solid bisphenol-A epoxy resin, an epoxidized bisphenol F epichlorohydrin ether polymer, a creosol or novalac type epichlorohydrin ether polymer, a combination thereof or the like.

The epoxy component is preferably composed at least partially or substantially entirely of a relatively low average molecular weight epoxy resin. Preferably, the epoxy resin in a di-functional resin and has a molecular weight between about 200 atomic mass units (amu) or less and about 2000 amu or more, more preferably between about 400 amu and about 1500 amu and even more preferably between about 900 amu and about 1300 amu. The epoxy equivalent weight (EEW) of the epoxy component or resin is preferably between about 100 EEW or less and about 1000 EEW or greater, more preferably between about 200 EEW and about 750 EEW and even more preferably between about 450 EEW and about 650 EEW. It is also preferable for a solid epoxy component or resin to have a softening pOint or temperature between about 30° C. or less and about 100° C. or greater, more preferably between about 45° C. and about 85° C. and even more preferably between about 65° C. and about 80° C.

The elastomeric component may be any suitable art disclosed elastomer or mixture of elastomers such as a thermosetting elastomer. In preferred embodiments, the adduct includes up to about 60% or more by weight of an elastomeric component. More preferably, the adduct includes between about 10% and 45% by weight elastomeric component and still more preferably between about 15% and 25% by weight elastomeric component.

Exemplary elastomers include, without limitation natural rubber, styrene-butadiene rubber, polyisoprene, polyisobutylene, polybutadiene, isoprene-butadiene copolymer, neoprene, butyl rubber, polysulfide elastomer, acrylic elastomer, acrylonitrile elastomers, silicone rubber, polysiloxanes, polyester rubber, diisocyanate-linked condensation elastomer, EPDM (ethylene-propylene diene rubbers), chlorosulphonated polyethylene, fluorinated hydrocarbons and the like. In one embodiment, recycled tire rubber is employed. According to one preferred embodiment, the elastomeric component is partially or substantially entirely composed of a nitrile rubber (e.g., a butyl nitrile). If such a nitrile rubber is employed, the rubber preferably includes between about 10% or less and about 50% or more by weight nitrile, more preferably between about 20% and about 40% by weight nitrile and even more preferably between about 25% and about 35% by weight nitrile.

The elastomeric component is preferably composed at least partially or substantially entirely of a relatively low mooney viscosity elastomer. Preferably, the elastomeric component has a mooney viscosity of between about 10 or less and about 50 or greater, more preferably between about 15 and about 40 and even more preferably between about 22 and about 35 at a temperature of 100° C. In a preferred embodiment, the elastomeric component includes one or more carboxyl groups (e.g., carboxylic acid groups) such as a carboxyl-terminated elastomer. The elastomeric component may also include pendant carboxy or carboxyl groups. In such an embodiment the elastomeric component preferably has a carboxyl content of between about 0.005 equivalents per hundred rubber (EPHR) or less and about 0.4 EPHR or greater, more preferably between about 0.01 EPHR and about 0.2 EPHR and even more preferably between about 0.05 EPHR and about 0.1 EPHR.

While the two main components of the adduct may be the elastomeric component and the epoxy component, it is contemplated that various additives may be included in the adduct. For example, and without limitation, the adduct may include additives such as flexibility agents, rheology modifiers, plasticizers, catalysts, UV resistant agents, flame retardants, curing agents, impact modifiers, heat stabilizers, colorants, processing aids, lubricants, fillers, reinforcement materials (e.g., chopped or continuous glass, ceramic, aramid, or carbon fiber) combinations thereof or the like.

Examples of fillers include silica, diatomaceous earth, glass, clay, talc, pigments, colorants, glass beads or bubbles, glass, carbon ceramic fibers, antioxidants, and the like. Such fillers, particularly clays, can assist the expandable material in leveling itself during flow of the material. The clays that may be used as fillers may include clays from the kaolinite, illite, chloritem, smecitite or sepiolite groups, which may be calcined. Examples of suitable fillers include, without limitation, talc, vermiculite, pyrophyllite, sauconite, saponite, nontronite, montmorillonite or mixtures thereof. The clays may also include minor amounts of other ingredients such as carbonates, feldspars, micas and quartz. The fillers may also include ammonium chlorides such as dimethyl ammonium chloride and dimethyl benzyl ammonium chloride.

Other fillers include mineral or stone type fillers such as calcium carbonate, sodium carbonate or the like. It is also contemplated that silicate minerals such as mica may be used as fillers. Further, metal-containing materials such as titanium dioxide, aluminum materials (e.g., alumina trihydrate) might also be employed.

When employed, the fillers in the adduct can range from 0.1% to 40% by weight of the adduct. Preferably, the adduct includes between about 1% and about 10% by weight filler and more preferably between about 2% and about 7% by weight filler.

For exemplary purposes, tables A and B are produced below to illustrate two exemplary formulations for forming the epoxy/elastomer adduct.

TABLE A

| Ingredient | Weight % |
|---|---|
| Solid Epoxy Resin KER 1001 MSQ | 72 |
| Carboxylated NBR Rubber Nipol 1472X | 23 |
| Calcium Carbonate filler | 4.90 |
| Catalyst, triphenylphosphine | 0.10 |

TABLE B

| Ingredient | Weight % |
|---|---|
| Solid Epoxy Resin KER 1001 MSQ | 76.00 |
| Carboxylated NBR Rubber Nipol 1472X | 19.00 |
| Garamite 1958 viscosity modifier | 4.900 |
| Catalyst, triphenylphosphine | 0.100 |

It should be understood that various ingredients may be substituted, added or removed from the above formulations without departing from the scope of the present invention. Moreover, it is contemplated that the weight percentages of the above ingredients may vary up to or greater than ±5%, ±10%, ±25% or ±50%.

Formation of the adduct may be accomplished according to a variety of methodologies. Generally, the elastomeric component, the epoxy component and any additives are typically mixed in a batch type process to form the adduct as a substantially homogeneous mixture. For example, the epoxy component and the elastomeric component may be dispensed to a mixer (e.g., a high shear mixer) and mixed until the adduct is formed in a substantially homogeneous state. Preferably, the mixing takes place at a temperature between about 50° C. or lower and 250° C. or higher, more preferably between about 70° C. and about 200° C. and even more preferably between about 90° C. and about 160° C. Thereafter, the adduct may be allowed to cool and solidify or may cool and remain as a semi-solid or a liquid.

In one embodiment, the adduct is formed using a continuous mixing process such as by mixing the ingredients of the adduct in an extruder. In such an embodiment, the components of the adduct can be fed into an extruder at various different locations along the length of the extruder. Then, one or more screws of the extruder typically rotate and intermix the components of the adduct.

The adduct may be formed using a variety of extruders including, without limitation, a single screw extruder, a continuous kneader, one or more of the various types of multi-screw extruders, a combination thereof or the like. Multi-screw extruders include twin or two-screw extruders or extruders having three, four or more screws. Such extruders can include non-intermeshing screws, intermeshing screws, co-rotating screws, counter-rotating screws, combinations thereof or the like. The extruder can be self wiping or non-self wiping and can include a large range of possible configurations of screw element types and arrangements. For example, one preferred twin screw extruder is a self-wiping, intermeshing, co-rotating twin screw extruder.

The actual screws of extruders, particularly of the twin-screw extruders, typically have a screw length to screw diameter ratio of at least about 16:1, more typically at least about 24:1, even more typically at least about 32:1 and still more typically at least about 40:1. In such instances the diameter of the screw is typically between about 10 mm and about 150 mm, more typically between about 15 mm and about 90 mm and even more typically between about 20 mm and about 40 mm. The extruder used to form the adduct will typically have temperature set points, as that term is used in the art, along the extruder of between 40° C. and about 300° C. but more typically between about 60° C. to 200° C., although no such set points are necessarily required. An example of one desirable extruder is a twin screw extruder having multiple barrel sections sold under the tradename CT-25 and is commercially available from B&P Process Equipment and Systems, Saginaw, Mich.

For forming the epoxy elastomer adduct, the ingredients of the adduct are fed to one or more input locations (e.g., a first end) of the extruder having an opening suitable for receipt of the ingredients. The one or more screws of the extruder then rotate and move the ingredients toward one or more output locations (e.g., a second end opposite the first end) of the extruder while concurrently mixing and preferably elevating the temperature of the ingredients thereby forming the adduct. As an example, the extruder preferably exposes the ingredients, the adduct or both to screw speeds typically between 50 revolutions per minute (rpm) and 1250 rpm, more typically between about 250 rpm and 900 rpm and even more typically between about 500 rpm and about 750 rpm.

During travel of the ingredients through the extruder, it may be desirable to degas (e.g., at about −20 in. Hg ±50%) the ingredients particularly at a location adjacent the one or more output locations where the ingredients have substantially or entirely formed the epoxy/elastomer adduct. At the one or more output locations, the adduct is typically fed through a die, although not required.

It is contemplated that that the elastomeric component may be only slightly non-reactive with the epoxy component during mixing. Preferably, however, the elastomeric component at least partially reacts with the epoxy component to form one or more reaction products as at least part of the adduct. According to one preferred embodiment, wherein the elastomeric component includes one or more carboxyl groups (e.g., carboxylic acid groups), the carboxyl groups will typically react with oxirane rings of the epoxy component to form reaction products such as esters during mixing. When formed in an extruder, the adduct, upon emission from the extruder, typically exhibits a capillary viscosity of greater than about 500 Pa-s or less, more typically greater than about 800 Pa-s, even more typically greater than about 1000 Pa-s and may be even greater than about 1200 Pa-s at an apparent shear rate of 400 1/s and 100° C. to assure that such reactions have substantially occured.

It may be desirable to increase temperature during mixing for accelerating the reaction rates. It has been found that mixing a temperature of about 120° C. or higher, more preferably about 140° C. or higher and even more preferably about 150° C. or higher can significantly increase reaction rates between the elastomeric component and the epoxy component. As an alternative, a catalyst may be employed preferably during mixing for accelerating reaction rates. When used, the adduct preferably includes between about 0.001% or less and about 5.0% or more by weight of a catalyst and more preferably between about 0.01% and about 3.0% by weight catalyst and even more preferably between about 0.05% and about 1.0% by weight catalyst. Although it is contemplated that any suitable catalyst may be used, preferred exemplary catalysts include phosphines (e.g., thriphenyl phosphine), amines, imidazoles, phosphoniums, iodides (e.g., ethyl triphenyl phosphonium iodide), metal catalysts, combinations thereof or the like.

The final properties of the adduct such as viscosity, EEW, and amount of unreacted components (e.g., carboxylic or oxirane groups) can vary and typically depend upon various factors such as reaction rates, time and temperature of reaction, degree of reaction or the like. The viscosity and EEW of the adduct can be raised or lowered by using an epoxy component (e.g., epoxy resin) with correspondingly higher or lower molecular weight and/or higher or lower EEW. It is also contemplated that at least a portion or a substantial portion of the epoxy component may be a liquid or solid multifunctional epoxy resin. For determining the degree or extent of reaction within the adduct, it may be desirable to test samples using chemical composition determination devices or methods such as infrared spectroscopy or the like.

The desired properties for the adduct typically depend upon the ultimate use of the adduct. In preferred embodiments , the adduct ha s a viscosity of between about 100 Pas or less and 1500 Pas or greater, more preferably between about 300 Pas and about 1200 Pa s and even more preferably between about 500 Pas and about 900 Pas at a temperature of 100° C. and shear rate of 400 s⁻¹.

The amount of unreacted components (e.g. unreacted carboxyl groups) is typically kept to a minimum for imparting longer shelf life to the adduct. However, it is contemplated that larger portions of unreacted components may be desired for certain applications. According to one preferred embodiment, a reactive additive may be included for assisting in completion of any reactions within the adduct. For example, a reactive additive may be employed for capping carboxyl groups of the elastomer component for reducing cross-linking of the epoxy component, the elastomeric component or both. Preferably the reactive additive has relatively low viscosity, a low functionality (e.g., less that 2 and more preferably less than 1.3) or both. Exemplary reactive additives include, without limitation, glycidyl ether of phenol or cresol.

The reactive additive may be selected from a variety of materials, when used. In one preferred embodiment, the reactive additive is a reactive diluent, which may be polymeric or non-polymeric, aliphatic or aromatic, and preferably includes one or more relative epoxy groups (e.g., may be a monofunctional or polyfunctional epoxy). Preferably, the reactive additive has a relatively low viscosity. Preferred reactive additives have a viscosity of less than about 25,000 centipoise or greater, more preferably between about 3 and about 100 centipoise and even more preferably between about 5 and about 10 centipoise at a temperature of about 25° C. When used, the relative additive is preferably present in the adduct in an amount between about 0.001% by weight or less and about 10% by weight or higher, more preferably between about 0.1% by weight and about 5% by weight and even more preferably between about 1% by weight and about 3% by weight of the adduct.

Advantageously, it has been found that adducts of the present invention may be formed as relatively high viscosity melts without any substantial amount of solvent (i.e., a substantial amount being greater than about 2% by weight solvent in the adduct) or without any solvent at all. In turn, the adduct may be formed, processed or the like at a lower cost, with fewer volatile emissions, combinations thereof or the like. It has also been found that the adduct formed according to the present invention can still include a relatively high level of solid elastomer without requiring any substantial amount of solvent or without any solvent at all. For example, the adduct may include greater than about 15% by weight solid elastomer, more preferably greater than about 20% by weight solid elastomer and even greater than about 30% or 40% by weight elastomer.

Materials Having the Adduct

It is contemplated that the adduct may be used by itself. Preferably, however, the adduct is incorporated into a material, which may be used for structural reinforcement, adhesion, sealing, acoustical damping properties or a combination thereof. In one preferred embodiment, the adduct is employed in a heat activated material, which may be a structural adhesive such as the expandable material described in U.S. Provisional Patent Application Ser. No. 60/369,001, filed Apr. 1, 2002, titled “Expandable Material” and incorporated herein by reference for all puposes.

The adduct may also be mixed or incorporated into a reinforcement material having high compressive and shear strengths. The material may be generally dry to the touch (e.g., non-tacky) or tacky and can be placed upon the surfaces of the members in any form of desired pattern, placement, or thickness, but is preferably a substantially uniform thickness. One exemplary expandable material is L-5204 structural foam available through L&L Products, Inc. of Romeo, Mich.

The adduct may be included in a heat activated material such as an expandable plastic. A particularly preferred material is an epoxy-based structural foam. For example, without limitation, the structural foam may be an epoxy-based material, including an ethylene copolymer or terpolymer that may possess an alpha-olefin. As a copolymer or terpolymer, the polymer is composed of two or three different monomers, i.e., small molecules with high chemical reactivity that are capable of linking up with similar molecules.

The adduct may be incorporated into a number of epoxy-based foams, adhesive materials or a combination thereof. A typical foam, adhesive or the like includes a polymeric base material, such as, the materials disclosed herein, an epoxy resin or ethylene-based polymer which, when compounded with appropriate ingredients (typically a blowing and curing agent), expands, cures or both in a reliable and predicable manner upon the application of heat or the occurrence of a particular ambient condition. From a chemical standpoint for a thermally-activated material, the foam or adhesive is usually initially processed as a flowable thermoplastic material before curing. It will cross-link upon curing, which makes the material substantially incapable of further flow.

An example of a preferred foam or adhesive is an epoxy-based material that is commercially available from L&L Products of Romeo, Mich., under the designations L5206, L5207, L5208, L5209, XP321, XP8100 and XP721. One advantage of the preferred foam or adhesive materials over prior art materials is that the preferred materials can be processed in several ways. The preferred materials can be processed by injection molding, extrusion compression molding or with a mini-applicator (e.g., a mini-extruder). This enables the formation and creation of part designs that exceed the capability of most prior art materials.

The adduct may be incorporated into a variety of other materials as well. Preferably, the material selected is heat-activated or otherwise activated by an ambient condition (e.g. moisture, pressure, time or the like) and cures in a predictable and reliable manner under appropriate conditions for the selected application. One such material is the epoxy based resin disclosed in U.S. Pat. No. 6,131,897, the teachings of which are incorporated herein by reference, filed with the United States Patent and Trademark Office on Mar. 8, 1999 by the assignee of this application. Some other possible materials include, but are not limited to, polyolefin materials, copolymers and terpolymers with at least one monomer type an alpha-olefin, phenol/formaldehyde materials, phenoxy materials, and polyurethane materials with high glass transition temperatures. See also, U.S. Pat. Nos. 5,766,719; 5,755,486; 5,575,526; and 5,932,680, (incorporated by reference).

In applications where the adduct is incorporated into a material that is a heat activated, thermally expanding material, an important consideration involved with the selection and formulation of the material is the temperature at which a material reaction or expansion, and possibly curing, will take place. For instance, in most applications, it is undesirable for the material to be reactive at room temperature or otherwise at the ambient temperature in a production line environment. More typically, it is desirable for the material to become reactive at higher processing temperatures, such as those encountered in an automobile assembly plant, when the material is processed along with the automobile components at elevated temperatures or at higher applied energy levels, e.g., during painting preparation steps. While temperatures encountered in an automobile assembly operation may be in the range of about 148.89° C. to 204.44° C. (about 300° F. to 400° F.), body and paint shop applications are commonly about 93.33° C. (about 200° F.) or slightly higher. If needed, blowing agent activators can be incorporated into the material to cause expansion at different temperatures outside the above ranges.

Some other possible materials suitable for including the adduct are polyolefin materials, copolymers and terpolymers with at least one monomer type an alpha-olefin, phenol/formaldehyde materials, phenoxy materials, and polyurethane. See also, U.S. Pat. Nos. 5,266,133; 5,766,719; 5,755,486; 5,575,526; 5,932,680; and WO 00/27920 (PCT/US 99/24795) (all of which are expressly incorporated by reference). In general, the desired characteristics of the resulting material include relatively high glass transition point (e.g., above typical ambient temperatures), and good adhesion durability properties. In this manner, the material does not generally interfere with the materials systems employed by automobile manufacturers. Moreover, it will withstand the processing conditions typically encountered in the manufacture of a vehicle, such as the e-coat priming, cleaning and degreasing and other coating processes, as well as the painting operations encountered in final vehicle assembly.

It is contemplated that the adduct may be included in a material that is provided in an encapsulated or partially encapsulated form, which may comprise a pellet that includes an expandable foamable material, encapsulated or partially encapsulated in an adhesive shell. An example of one such system is disclosed in commonly owned, co-pending U.S. application Ser. No. 09/524,298 (“Expandable Pre-Formed Plug”), hereby incorporated by reference. It is also contemplated that the adduct may be incorporated into a two-component system such as an epoxy/amine system or an epoxy/acid system wherein the polymeric or epoxy activates, expands and/or cures upon addition of the curative (e.g., the amine or acid).

Advantageously, expandable adhesive materials that include the adduct have exhibited improved lap shear strength greater than 1500 psi and more preferably greater than 1700 psi. Such adhesive materials have also exhibited peel strength greater than 45 lbs/in, more preferably greater than 65 lbs/in and even more preferably greater than 75 lbs/in. Additionally, such adhesive materials have exhibited reduced property (e.g., strength or bonding) sensitivity to bondline size (e.g., thickness) of an applied adhesive material. Such lack of property (e.g., strength) sensitivity has also been exhibited by expandable or foamable materials, which expand to a volume that is at least 120% their original unexpanded volume and even to a volume that is at least 140% or at least 170% their original unexpanded volume.

For exemplary purposes, table C is produced below to illustrate an exemplary formulation for forming the epoxy/elastomer adduct.

TABLE C

| Ingredient | Weight % |
|---|---|
| Epoxy/Elastomer Adduct | 50% |
| (e.g., Solid Rubber/Solid Epoxy Adduct) | |
| Epoxy Resin | 30% |
| (e.g., Standard Liquid Epoxy, EEW approx. 190 g/mol) | |
| Elastomer (e.g., Carboxy Terminated Nitrile Rubber) | 10% |
| Filler (e.g., Calcium Carbonate) | 4.9% |
| Curing Agent (e.g, Dicyandiamide) | 3.0% |
| Filler (e.g., Nanoclay) | 1.0% |
| Curing Agent | 0.7% |
| (e.g, 4,4' Methylene bis(phenyl dimethyl urea)) | |
| Azodicarbonamide blowing agent | 0.4% |

It should be understood that various ingredients may be substituted, added or removed from the above formulation without departing from the scope of the present invention. Moreover, it is contemplated that the weight percentages of the above ingredients may vary up to or greater than ±5%, ±10%, ±25% or ±50% (e.g., the 30% by weight epoxy resin ±5% is 25% to 35%).

As one advantage, the adduct, when made without solvent, can also be incorporated into one of the materials discussed above without the use of any substantial solvent or without any solvent at all being mixed with the material or the adduct. For example, the ingredients of the materials may be mixed in a batch process or in an extruder without the use of any solvents. Of course, in certain embodiments, solvents may be employed if desired.

Articles

It is contemplated that the adduct may be applied to an article of manufacture by itself, as part or another material or the like. As another alternative, the adduct or a material including the adduct may be applied to a carrier or intermediate member followed by applying the material and the carrier to an article of manufacture. As discussed previously, preformed patterns of the adduct or adduct containing materials may be employed such as those made by extruding a sheet or tape (having a flat or contoured surface) and then die cutting it according to a predetermined configuration in accordance with the chosen structure, member or surface and applying it thereto.

In one embodiment, an adduct formed according to the present invention is incorporated into a sealing material and the sealing material is applied to an article of manufacture such as an automotive vehicle. Preferably the sealing material is applied to an intersection of two portions or members (e.g., overlapping sections of panels or members, abutting sections of panels or member, combinations thereof or the like). It is also preferable to apply the sealing material to opening, holes, cavities or the like of articles of manufacture. As an example, the sealing material might be applied to overlapping portions of panels that form a roof ditch of an automotive vehicle. In still other embodiments, the adduct may be incorporated into an adhesive material that is employed for assisting in attaching a first member or component to a second member or component.

Other applications for which the present technology may be adapted or employed as an adduct containing material including those of the type identified in U.S. Pat. Nos. 6,358,584; 6,311,452; 6,296,298, all of which are hereby incorporated by reference. The material of the present invention may thus be applied to a carrier, such as a molded, extruded or stamped member (e.g., metal or plastic, foamed or unfoamed; exemplary materials of which include aluminum, magnesium, titanium, steel, polyamide (e.g., nylon 6 or nylon 6,6), polysulfone, thermoplastic imide, polyether imide, polyether sulfone or mixtures thereof. Moreover, a material incorporating the adduct might be applied as a reinforcing patch to a panel, for instance, with a fiberglass fabric (e.g., a woven roving) layered on the material.

The preferred embodiment of the present invention has been disclosed. A person of ordinary skill in the art would realize however, that certain modifications would come within the teachings of this invention. Therefore, the following claims should be studied to determine the true scope and content of the invention.

1-23. (canceled)

24: A method of forming an epoxy/elastomer adduct, the method comprising:
providing an epoxy component;
providing an elastomer, the elastomer being a nitrile rubber, wherein at least one of the epoxy component and the elastomer is a solid;
melt mixing the epoxy component with the elastomer such that the epoxy component reacts with the elastomer to form the adduct, the elastomer being at least 15% by weight of the adduct.

25: A method as in claim 24 wherein the melt mixing is accomplished substantially without solvent.

26: A method as in claim 24 melt mixing in the presence of a catalyst the catalyst being selected from a phosphine and an iodide.

27: A method as in claim 24 wherein the epoxy component is between about 70% and about 85% by weight of the adduct and the elastomer is at least about 20% by weight of the adduct.

28: A method as in claim 24 wherein the epoxy component is provided as a phenolic resin and wherein the adduct exhibits a viscosity of at least about 500 Pa-s at a temperature of about 100° C. and a shear rate of 400 s⁻¹.

29: A method as in claim 24 wherein the epoxy component has a molecular weight between about 900 amu and about 1300 amu, an epoxy equivalent weight between about 100 EEW g/mol and about 1000 EEW and a softening point between about 65° C. and about 75° C.

30: A method as in claim 24 wherein the elastomer is between about 15% and about 35% by weight of the adduct and the elastomer has a carboxyl content of between about 0.05 and about 0.1 equivalents per hundred rubber.

31: A method as in claim 24 further comprising a reactive diluent wherein the adduct exhibits a viscosity of at least about 600 Pa-s at a temperature of about 100° C. and a shear rate of 400 s⁻¹.

32: A method as in claim 24 wherein the step of mixing includes introducing the epoxy component, in a solid state, and the elastomer, in a solid state, to an extruder, which melts and mixes the epoxy component with the elastomer.

33: A method of forming an epoxy/elastomer adduct, the method comprising:
providing a solid epoxy component, wherein the epoxy component is provided as a phenolic resin including at least one of a solid bisphenol-A epichlorohydrin ether polymer or a solid bishpenol-A epoxy resin;
providing a solid elastomer, the elastomer being a carboxylated butadiene nitrile rubber;
melt mixing, substantially without solvent, the epoxy component with the elastomer in the presence of a catalyst such that the epoxy component reacts with the elastomer to form the adduct with the elastomer being at least 15% by weight of the adduct and the epoxy component being between about 50% and about 90% by weight of the adduct, the catalyst being selected from a phosphine and an iodide; and
solidifying the adduct.

34: A method as in claim 33 wherein the elastomer is at least 20% by weight of the adduct.

35: A method as in claim 33 Wherein the elastomer is between about 30% and about 40% by weight of the adduct.

36: A method as in claim 33 wherein the epoxy component has a molecular weight between about 900 amu and about 1300 amu, an epoxy equivalent weight between about 100 EEW g/mol and about 1000 EEW and a softening point between about 65° C. and about 75° C.

37: A method as in claim 33 wherein the elastomer is between about 15% and about 35% by weight of the adduct and the elastomer has a carboxyl content of between about 0.05 and about 0.1 equivalents per hundred rubber.

38: A method as in claim 33 further comprising a reactive diluent wherein the adduct exhibits a viscosity of at least about 600 Pa-s at a temperature of about 100° C. and a shear rate of 400 s⁻¹.

39: A method as in claim 33 wherein the step of mixing includes introducing the epoxy component, in a solid state, and the elastomer, in a solid state, to an extruder, which melts and mixes the epoxy component with the elastomer.

40: A method as in claim 33 further comprising mixing the adduct with a filler, a curing agent and a blowing agent.

41: A method of forming an epoxy/elastomer adduct, the method comprising:
providing a solid epoxy component composed substantially entirely of a solid bisphenol-A epoxy resin, the epoxy resin having a molecular weight of between about 400 amu and about 1500 amu, the epoxy resin having between about 200 EEW and about 750 EEW, the epoxy resin having a softening point between about 45° C. and about 85° C.;
providing a solid elastomer, the elastomer being a carboxylated butadiene nitrile rubber, the elastomeric component having a mooney viscosity of between about 15 and about 40 at a temperature of 100° C. and having a carboxyl content of between about 0.01 EPHR and about 0.1 EPHR and being between about 20% and about 40% by weight nitrile, wherein;
melt mixing, substantially without solvent, the epoxy component with the elastomer in the presence of a catalyst such that the epoxy component reacts with the elastomer to form the adduct with the elastomer being at least 20% by weight of the adduct and the epoxy component being is between about 70% and about 85% by weight of the adduct, the catalyst being selected from triphenyl phosphine or ethyl triphenyl phosphonium idodide; and
solidifying the adduct substantially by itself.

42: A method as in claim 41 wherein the mixing step produces an adduct that exhibits a viscosity of at least about 600 Pa-s at a temperature of about 100° C. and a shear rate of 400 s⁻¹.

43: A method as in claim 42 wherein the step of mixing includes introducing the epoxy component, in a solid state, and the elastomer, in a solid state, to an extruder, which melts and mixes the epoxy component with the elastomer.
